(19) United States
(12) Patent Application Publication
(10) Pub. No.: US 2020/0284064 A1
(43) Pub. Date: Sep. 10, 2020

(54) ELECTRONIC LOCK

(71) Applicant: YI-FAN LIAO, TAOYUAN CITY (TW)

(72) Inventor: YI-FAN LIAO, TAOYUAN CITY (TW)

(21) Appl. No.: 16/788,648

(22) Filed: Feb. 12, 2020

(30) Foreign Application Priority Data
Mar. 7, 2019 (TW) 108107656

(51) Int. Cl. E05B 47/00; E05B 9/00; E05B 15/00

(52) U.S. Cl. CPC E05B 47/0012; E05B 9/002; E05B 2047/0023; E05B 2047/0017; E05B 15/0053

(57) ABSTRACT

An electronic lock having a lock box arranged in the jamb and a face plate arranged in the door edge, the lock box has a brake gear with a screw sleeve arranged on a screw rod for driving the screw sleeve to displace back and forth, and by driving the rear end of the latch bolt, make the front end of the latch bolt be able to rotate inside the containing space of the lock box and go into or out of the bolt slot, and further goes into the lock slot of the face plate to achieve locking status; or the restoring of the expansion spring makes the latch bolt returned to the containing space to become unlocking status. Because the latch bolt is using the rotation to go in or out of the bolt slot and the screw sleeve and the screw rod which driving the latch bolt has the characteristic of high torque transmission, the present invention can ensure the operation stability of the lock during the locking and unlocking process.

### BACKGROUND OF THE INVENTION

### 1. Field of the Invention

The invention relates to an electronic lock, especially to one that uses a screw sleeve and a screw rod to drives a pivoting latch bolt going into or out a bolt slot for controlling the lock.

### 2. Description of the Related Art

General electronic lock is a concealed door lock arranged in the jamb, the conventional electronic lock showing in FIG. 1 uses an electromagnetic device to push the latch bolt 91 out of the jamb 92 along the X axis and go into the lock slot 94 of the face plate 93; since the shape and the size of the lock slot 94 are equal to the latch bolt 91, the latch bolt 91 can fit into the lock slot 94 horizontally so as to achieve effectively locked and concealment.

The electromagnetic device has many problems, including, when the door does not close properly while aligning the lock slot 94 to the latch bolt 91, the latch bolt 91 which displaced horizontally in X-X axis will hit the face plate 91 and fail to go into the lock slot 94 to complete locking process; or while the latch bolt is locked, the latch bolt 91 which displaced horizontally in X-X axis might break away from the lock slot 94 when the wind pressure or loads imposed by others is larger than the electromagnetic force. Therefore, to change the movement of the latch bolt 91 from horizontal movement to the rotation while going in or out the lock slot 94, and to enhance the torque to overcome loads problems are objectives of the present invention.

### SUMMARY OF THE INVENTION

It is a primary objective of the present invention to provide an electronic lock which uses a rotation mechanism for the latch bolt to get in and out the bolt slot to replace conventional horizontal pushing method to complete locking or unlocking process.

It is another objective of the present invention to provide an electronic lock which uses the advantage of high torque transmission characteristics of a screw sleeve and a screw rod to ensure the operation stability of the lock during the locking and unlocking process.

In order to achieve the above objectives, the lock box of the present invention arranged inside the jamb comprising: a door strike having a cap arranged outside and a containing space arranged inside thereof, and the cap has a bolt slot; a latch bolt, the latch bolt has a pivot hole at the rear end set through and fixed by a pivot for making the latch bolt able to rotate inside the containing space; a driving mechanism is arranged inside the containing space for driving the latch bolt extend through from the bolt slot to the lock slot of the face plate during locking process and return to the containing space during unlocking process; a side cover arranged at the lateral side of the containing space of the door strike for preventing dust; and a face plate having a lock slot.

The electronic lock is characterized in that: the lock slot of the face plate has a wide side and a narrow side and a bevel edge between thereof; on the pivot hole arranged a lug and behind the pivot hole arranged a guide bar, at the center of the guide bar arranged a guide wheel; a driving mechanism comprise a screw rod, a brake gear and an expansion spring; the screw rod is linked and drove by a motor and a decelerator; the brake gear has a screw sleeve, a pushing unit and a pull rod, the screw sleeve is set on the screw rod, the rotation of the screw rod drive the brake gear to displace axially to drive the pushing unit pushing the guide wheel of the latch bolt and to drive the pull rod to pull the guide bar of the latch bolt and further drive the front end of the latch bolt go into the bolt slot; the expansion spring is linked to lug and the fixing stud, during locking process, the expansion spring is stretched, and the expansion spring returned and further pull the front end of the latch bolt back to the containing space.

Whereby the rotation of the screw rod drives the brake gear to move forward, the pushing unit pushes the latch bolt to make the front end of the latch bolt extends throughout the bolt slot, and the latch bolt extends to the face plate from the wide side to the narrow side to guide the lock slot aligned to the bolt slot for the front end of the latch bolt going into the lock slot properly to be locked; the counterrotation of the screw rod drives the brake gear to move backward, the pull rod pulls the latch bolt back to the bolt slot, and the restoring of the expansion spring further makes the latch bolt returned to the containing space to be unlocked.

Also, the present invention further comprises a limited pin arranged at inner periphery of the bottom of the door strike for blocking the latch bolt while pulling by the expansion spring to make the latch bolt stay in the right position inside the containing space.

Also, away from the screw rod, the bottom of the door strike of arranged a horizontal rail and behind the pushing unit of the brake gear arranged a roller, and the roller is set on the horizontal rail, so when the screw rod drives the brake gear to move axially, the brake gear achieves the effect of smooth displacement.

Also, at the front end of the latch bolt arranged a rolling sleeve for the latch bolt rolling on the bevel edge of the lock slot to enhance the effect of guiding the lock slot aligned to the bolt slot.

Whereby the characteristics above mentioned, the present invention has below effects:

1). The lock box of the present invention arranged in the jamb has a pivot hole arranged at the rear end set through and fixed by a pivot inside the door strike, at the rear end of the pivot hole has a brake gear for driving the front end of the latch bolt to rotate inside the containing space, and further go in or out the bolt slot of the lock box; and the face plate arranged at the door edge has a lock slot having a bevel edge with a wide side and a narrow side; therefore the latch bolt driving by rotation can complete the locking process even in the situation that the lock slot not aligned to the bolt slot.

2). The driving mechanism of the present invention comprises a screw rod, a brake gear and an expansion spring; the screw sleeve of the brake gear is arranged on the screw rod, the screw rod is drove by the motor to drive the brake gear moving back and forth axially, and further rotates the rear end of the latch bolt for the front end to go in or out the bolt slot of the lock box; since the screw sleeve and the screw rod has the characteristic of high torque transmission, the latch bolt drove by the brake gear can guide the lock slot aligned to the bolt slot during locking process and ensure the latch bolt able to get out from the lock slot while enduring the lateral load from the door during the unlocking process, and the expansion spring further make the latch bolt returned to the containing space, therefore the present invention can ensure the operation stability of the lock during the locking and unlocking process.

### BRIEF DESCRIPTION OF THE DRAWINGS

FIG. 1 is a schematic diagram illustrating a conventional electronic lock;

FIG. 2 is an exploded perspective views of the present invention;

FIG. 3A is an assembly perspective views of the present invention;

FIG. 3B is an assembly front views of the present invention;

FIG. 3C is a schematic diagram of driving mechanism;

FIG. 4A is an assembly perspective views of the lock box during locking process;

FIG. 4B is an assembly front views of the present invention during locking process;

FIG. 4C is a schematic diagram of driving mechanism during locking process;

FIG. 5A is an assembly perspective views of the present invention while being locked;

FIG. 5B is an assembly front views of the present invention while being locked;

FIG. 5C is a schematic diagram of driving mechanism while being locked;

FIG. 6 is a schematic diagram illustrating the arrangement of the electronic lock of the present invention in an applicable embodiment;

FIG. 7 is a schematic diagram illustrating the status of the latch bolt during locking or unlocking process;

FIG. 8 is another schematic diagram illustrating the status of the latch bolt during locking or unlocking process;

FIG. 9 is another schematic diagram illustrating the status of the latch bolt during locking or unlocking process.

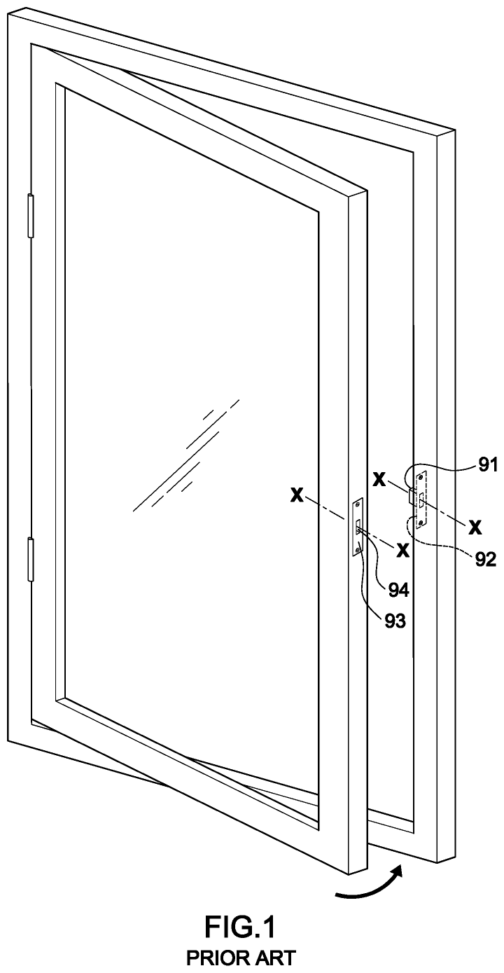

### DETAILED DESCRIPTION OF THE PREFERRED EMBODIMENT

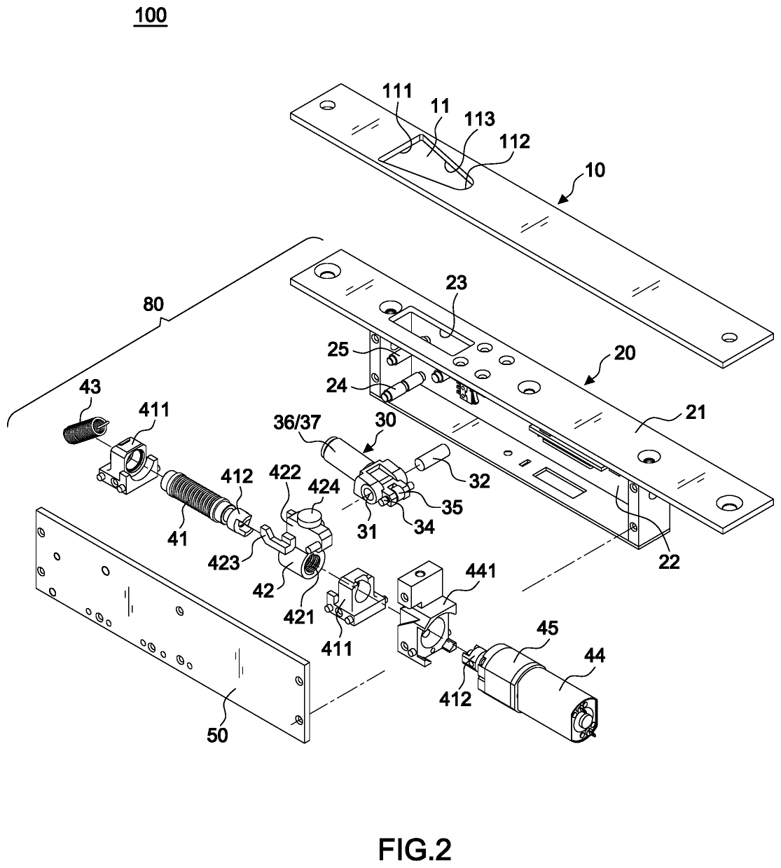

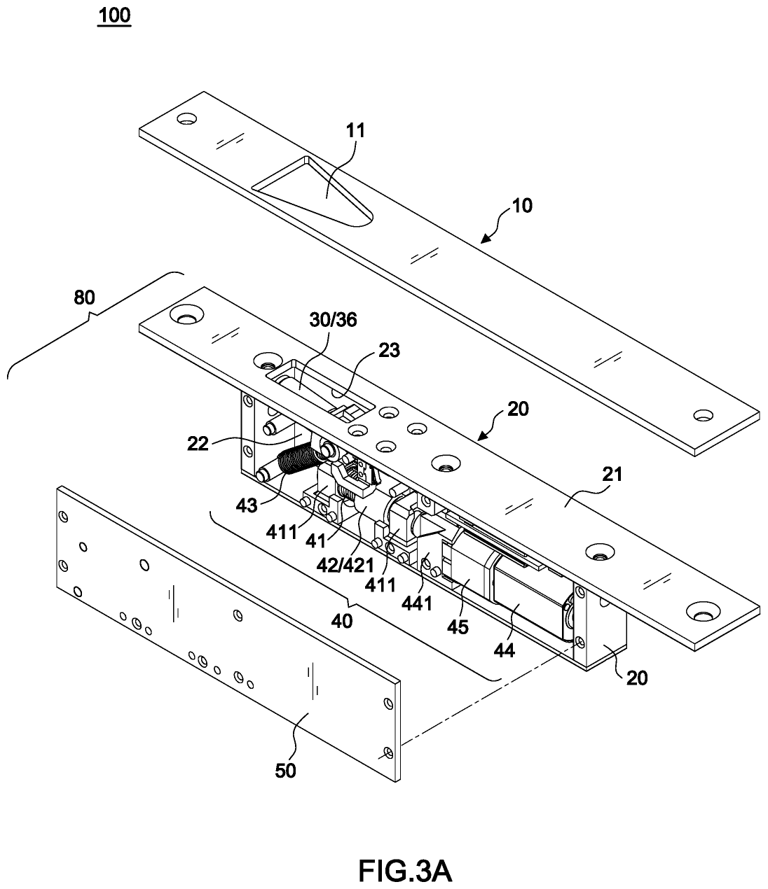

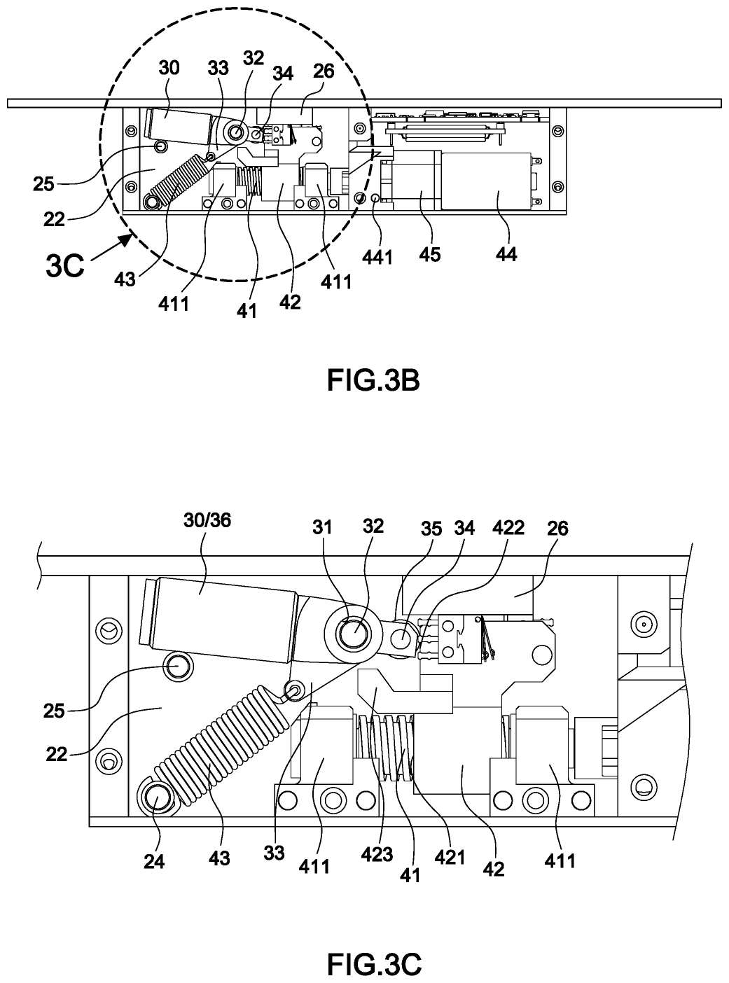

Referring to FIGS. 2-3C, the present invention electronic lock 100 comprise a lock box 80 and a face plate 10, the face plate 10 is arranged at the door edge and has a lock slot 11, and the lock slot 11 has a wide side 111 and a narrow side 112 and further forms a bevel edge 113; the lock box 80 arranged in the jamb comprise: a door strike 20 having a cap 21 arranged outside and a containing space 22 arranged inside thereof, and the cap 21 has a bolt slot 23; a latch bolt 30, the latch bolt 30 has a pivot hole 31, on the top of the pivot hole 31 has a lug 33, behind the pivot hole 31 arranged a guide bar 34, and at the center of the guide bar 34 arranged a guide wheel 35; the pivot hole 31 is set through and fixed by a pivot 32 for making the latch bolt 30 able to rotate inside the containing space 22 for making the front end 36 able to go in or out of the bolt slot 23; a driving mechanism 40 is arranged inside the containing space 22 to drive the latch bolt 30 for making the front end 36 able to go into the bolt slot 23 during the locking process and go into the lock slot 11 of the face plate 10, and be able to return to the containing space 22 during unlocking process.

The driving mechanism 40 above mentioned has a screw rod 41, a brake gear 42 and an expansion spring 43; wherein the screw rod 41 is set in the door strike 20 by an axle block 411 at the both end, and one end of the screw rod 41 is linked and drove by a motor 44 and a decelerator 45, and the decelerator 45 is set in door strike 20 by an axle block 411, and the screw rod 41 and the decelerator 45 is linked to each other by a coupling 412 for driving the screw rod 41 by the deceleration of the motor 44; the brake gear 42 has a screw sleeve 421, a pushing unit 422 and a pull rod 423, the screw sleeve 421 is set on the screw rod 41, the rotation of the screw rod 41 drive the brake gear 42 to displace axially to drive the pushing unit 422 pushing the guide wheel 35 of the latch bolt 30 and to drive the pull rod 423 to pull the guide bar 34 of the latch bolt 30, since the pivot hole 31 of the latch bolt 30 is set inside the door strike 20, the front end 36 of the latch bolt 30 will be drove and go into the bolt slot 23; the expansion spring 43 is linked to lug 33 and the fixing stud 24, during locking process, the expansion spring 43 is stretched, and during unlocking process, the expansion spring 43 returned and further pull the front end 36 of the latch bolt 30 back to the containing space 22; a side cover 50 arranged at the lateral side of the containing space 22 of the door strike 20 for preventing dust.

The present invention further comprises a limited pin 25 arranged at the inner periphery of the bottom of the door strike 20 for blocking the latch bolt 30 while pulling by the expansion spring 43 to make the latch bolt 30 stay in the right position inside the containing space 22. Also, away from the screw rod 41, the bottom of the door strike 20 arranged a horizontal rail 26 and behind the pushing unit 422 of the brake gear 42 arranged a roller 424, and the roller 424 is set on the horizontal rail 26, so when the screw rod 41 drives the brake gear 42 to move axially, the brake gear 42 achieves the effect of smooth displacement. Moreover, at the front end 36 of the latch bolt 30 arranged a rolling sleeve 37 for the latch bolt 30 rolling on the bevel edge 113 of the lock slot 11 to enhance the effect of guiding the lock slot 11 aligned to the bolt slot 23.

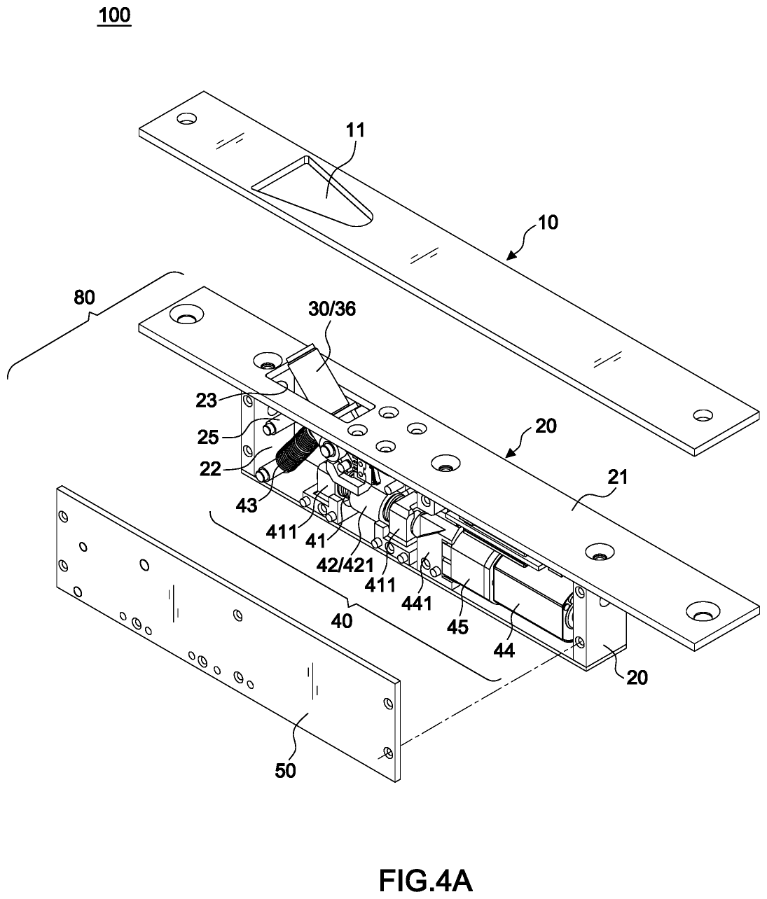

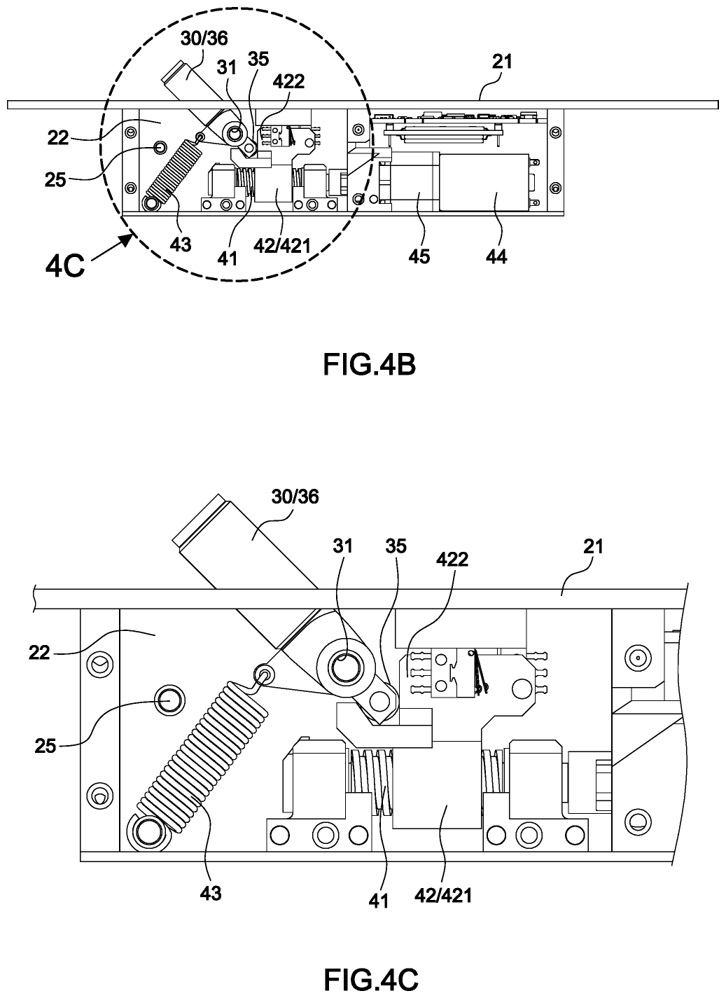

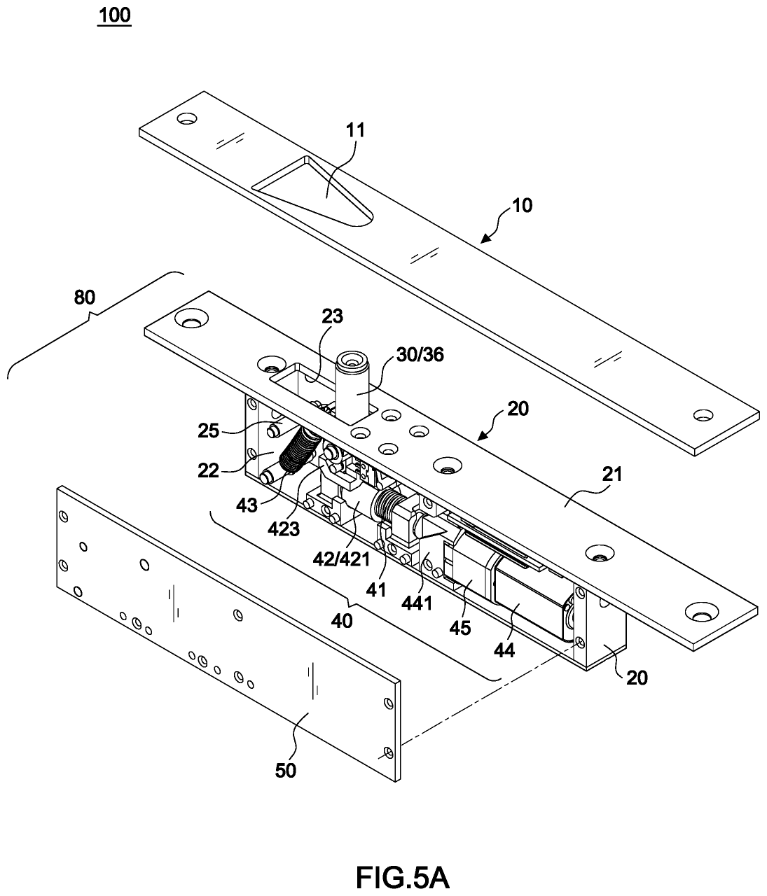

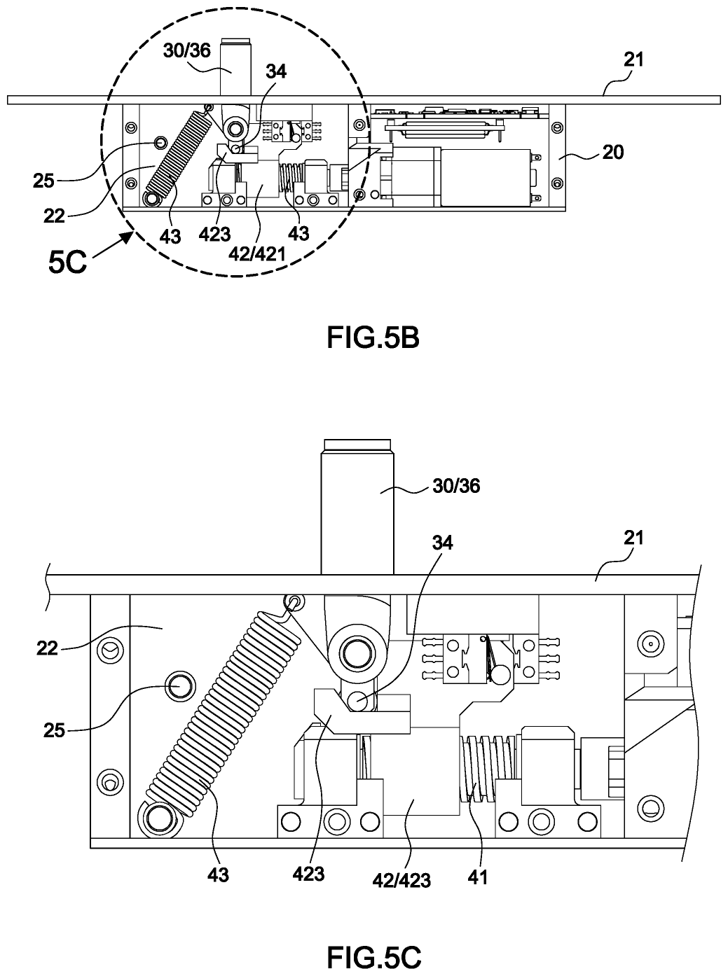

Referring to FIGS. 4A-4C, the diagram illustrating the operating of the present invention in locking process, at initial status, the latch bolt 30 stayed in the containing space 22, and then, the motor 44 linked to the decelerator 45 for driving the screw rod 41 to rotate, because the screw sleeve 421 of the brake gear 42 is arranged on the screw rod 41, the brake gear 42 displaced forward and the pushing unit 422 of the brake gear 42 further push the guide wheel 35 of the latch bolt 30, since the pivot hole 31 of the latch bolt 30 is set inside the door strike 20, when the front end 36 of the latch bolt 30 is drove and extended through out of bolt slot 23 and be vertical to the cap 21, and the latch bolt goes into the lock slot 11 of the face plate 10 and complete locking process, as FIGS. 5A-5C showing, the expansion spring 43 is stretched and accumulates strain energy.

The unlocking operating process of the present invention is opposite to the locking process, at initial status, the front end 36 of the latch bolt 30 is vertical to the cap 21 as FIG. 5A-5C showing, and the latch bolt 30 is in the lock slot 11 of the face plate 10; and then, the motor 44 linked to the decelerator 45 driving the screw rod 41 to rotate in opposite direction, the brake gear 42 displaced backward and the pull rod 423 of the brake gear 42 further pull the guide bar 34 of the latch bolt 30, the front end 36 of the latch bolt 30 is drove and retract to the bolt slot 23, and by the returning of the expansion spring 43 and the blocking of the limited pin 25, the he front end 36 of the latch bolt 30 is pulled into the containing space 22 and stayed in the right position and complete unlocking process, as FIGS. 3A-3C showing.

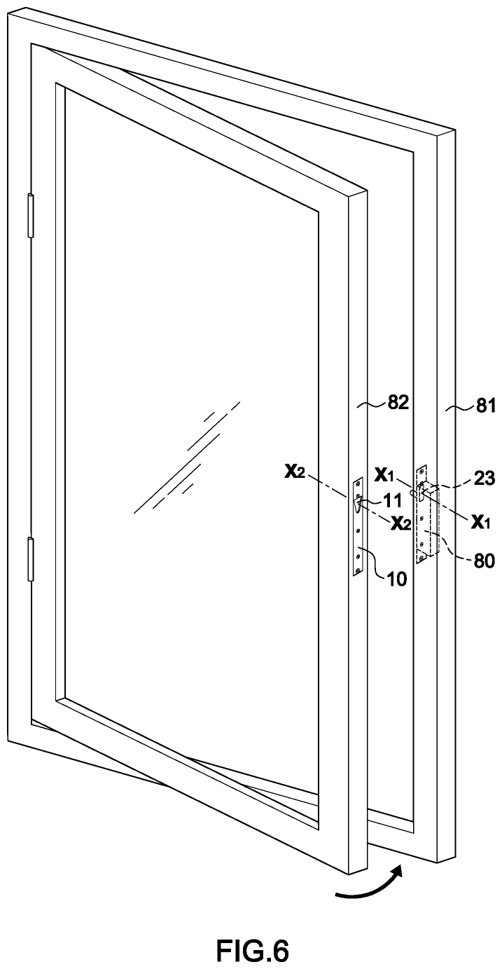

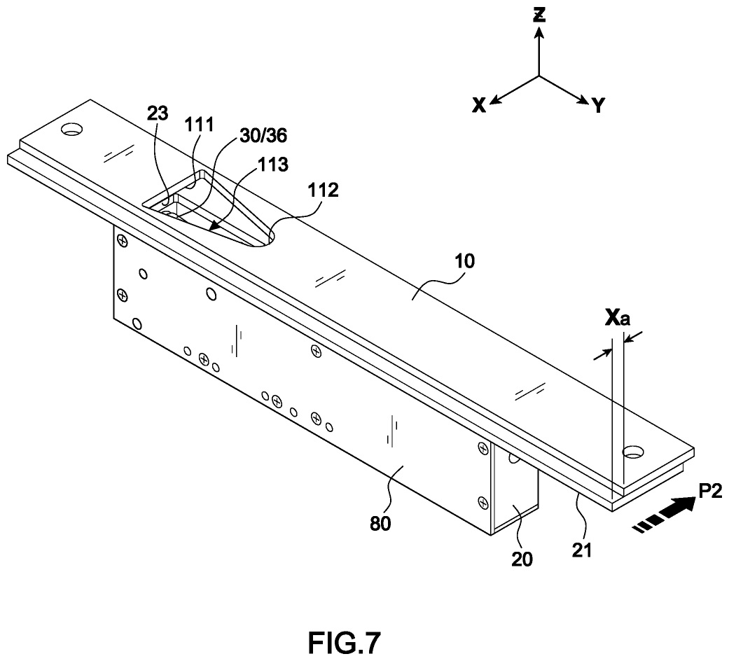

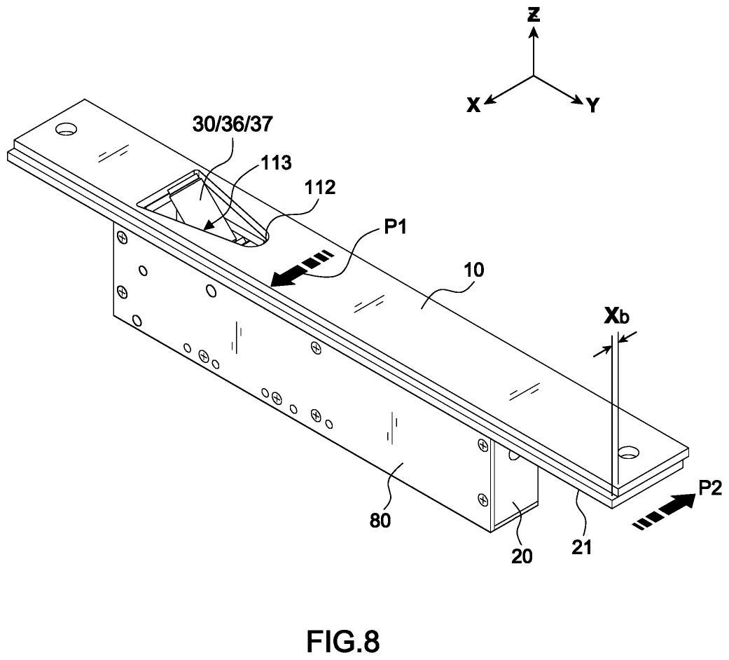

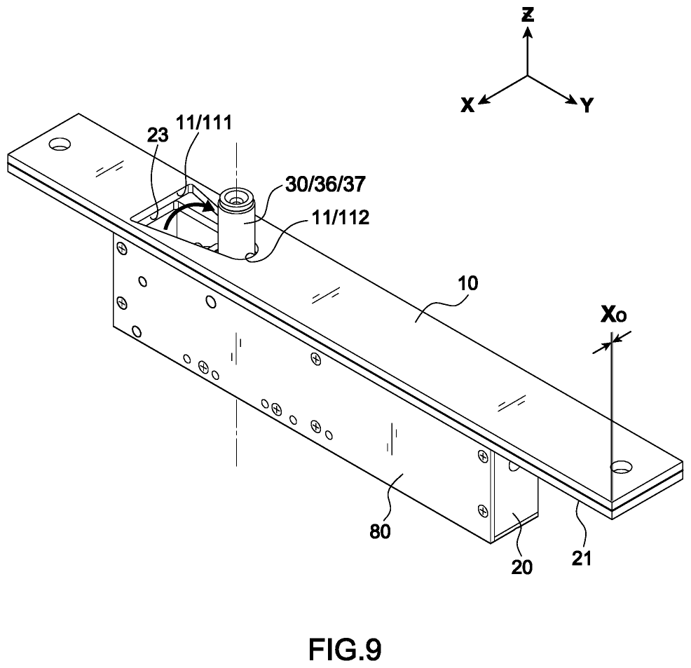

The FIG. 6 is an applicable embodiment of the installing method of the present invention, wherein the lock box 80 is arranged inside the jamb 81, the face plate 10 is set at the door edge 82 by aligning the horizontal axis X2-X2 of the lock slot 11 to the horizontal axis X1-X1 of the bolt slot 23; the installing method can also be arranging the lock box 80 on the door edge 82 and then set the face plate 10 inside the jamb 81; the locking process of the present invention is showing in FIGS. 7-9, during the locking process, the lock slot 11 of the face plate 10 may not be aligning to the bolt slot of the lock box 80, between the face plate 10 and the cap 21 of the lock box 80 has a first gap Xa, as FIG. 7 showing; then, the front end 36 of the latch bolt 30 goes into the lock slot 11 from the wide side 111. Because at the front end 36 of the latch bolt 30 has a rolling sleeve 37 for the front end 36 of the latch bolt 30 rolling on the bevel edge 113 of the lock slot 11 from the wide side 111 to the narrow side 112, the torque produced during the rolling process generates a X axis horizontal component P1 driving the face plate 10 to displace in X axis and further reduce the distance between face plate 10 and the cap 21 to form a smaller second gap Xb, as FIG. 8 showing; The front end 36 of the latch bolt 30 continues to roll along the bevel edge 113 of the lock slot 11 and making the lock slot 11 of the face plate 10 aligned to the bolt slot 23 of the lockbox 80, so as to make the face plate 10 and the cap 21 to have no gap X0, as FIG. 9 showing; moreover, the unlocking process of the present invention is showing in FIGS. 9-7, at first there is no gap X0 between the face plate 10 and the cap 21, as FIG. 9 showing, the lateral load of door P2 is smaller than the torque produced by the rotation of the latch bolt 30, so the rolling sleeve 37 of the latch bolt 30 will roll along the e bevel edge 113 of the lock slot 11 to the wide side 111, and the lateral load of door P2 will push the door and make a second gap Xb between the face plate 10 and the cap 21, as FIG. 8 showing; then, the front end 36 of the latch bolt 30 keeps rolling on the bevel edge 113 of the lock slot 11 until the front end 36 of the latch bolt 30 gets out from the lock slot 11 and the bolt slot 23, and the returning of the expansion spring 43 further pulls the front end 36 of the latch bolt 30 back to the containing space 22 to complete the unlocking process, then the lateral load of door P2 will push the door and make a first gap Xa between the face plate 10 and the cap 21, as FIG. 7 showing.

The lock box 80 of the present invention arranged in the jamb 81 has a pivot hole 31 arranged at the rear end of the latch bolt 30, the pivot hole 31 is set through by a pivot 32 fixed inside the door strike 20, and the brake gear 42 drives the rear end of the pivot hole 31 to make the front end 36 of the latch bolt 30 to be able to rotate in the containing space 22 and further goes into or out of the bolt slot 23 of the lock box 80; the face plate 10 arranged at the door edge 82 has a lock slot 11 having a wide side and a narrow side and a bevel edge between thereof; therefore, the latch bolt 30 driving by rotation can complete the locking process even in the situation that even the lock slot 11 is not aligned to the bolt slot 23. Furthermore, the driving mechanism 40 of the present invention comprises a screw rod 41, a brake gear 42 and an expansion spring 43; the screw sleeve 421 of the brake gear 42 is arranged on the screw rod 41, the screw rod 41 is drove by the motor 44 to drive the brake gear 42 moving back and forth axially, and further rotates the rear end of the latch bolt 30 for the front end 36 to go in or out of the bolt slot 23 of the lock box 80; since the screw sleeve 421 and the screw rod 41 has the characteristic of high torque transmission, the latch bolt 30 drove by the brake gear 42 can guide the lock slot 11 aligned to the bolt slot 23 during locking process and ensure the latch bolt 30 being able to get out from the lock slot 11 while enduring the lateral load from the door during the unlocking process, and the expansion spring 43 further make the latch bolt 30 returned to the containing space 22, therefore the present invention can ensure the operation stability of the lock during the locking and unlocking process.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An electronic lock, comprising a lock box and a corresponding face plate, wherein, said corresponding face plate has a lock slot, and the lock box comprising:
a door strike having a cap arranged outside and a containing space arranged inside thereof, and the cap has a bolt slot;
a latch bolt, the latch bolt has a pivot hole at the rear end set through and fixed by a pivot for making the latch bolt able to rotate inside the containing space;
a driving mechanism is arranged inside the containing space for driving the latch bolt extend through from the bolt slot to the lock slot of the face plate during locking process and return to the containing space during unlocking process;
a side cover arranged at the lateral side of the containing space of the door strike; wherein:
the lock slot of the face plate has a wide side and a narrow side and a bevel edge between thereof;
on the pivot hole arranged a lug and behind the pivot hole arranged a guide bar, at the center of the guide bar arranged a guide wheel;
said driving mechanism comprises a screw rod, a brake gear and an expansion spring; the screw rod is linked and drove by a motor and a decelerator; the brake gear has a screw sleeve, a pushing unit and a pull rod, the screw sleeve is set on the screw rod, the rotation of the screw rod drive the brake gear to displace axially, the displacement further drive the pushing unit pushing the guide wheel of the latch bolt and further drive the pull rod to pull the guide bar of the latch bolt, and further drive the front end of the latch bolt going into the bolt slot; the expansion spring is linked to the lug and the fixing stud, during locking process, the expansion spring is stretched, and during unlocking process, the expansion spring returned and further pull the front end of the latch bolt back to the containing space;
whereby the rotation of the screw rod drives the brake gear to move forward, the pushing unit pushes the latch bolt to make the front end of the latch bolt extends throughout the bolt slot, and the latch bolt extends to the face plate from the wide side to the narrow side to guide the lock slot aligned to the bolt slot for the front end of the latch bolt going into the lock slot properly to become locking status; the counterrotation of the screw rod drives the brake gear to move backward, the pull rod pulls the latch bolt back to the bolt slot, and the restoring of the expansion spring further makes the latch bolt returned to the containing space to become unlocking status.

2. The electronic lock as claimed in claim 1, wherein comprises a limited pin arranged at the inner periphery of the bottom of the door strike for blocking the latch bolt while pulling by the expansion spring to make the latch bolt stay in the right position inside the containing space.

3. The electronic lock as claimed in claim 1, wherein away from the screw rod of the bottom of the door strike arranged a horizontal rail and behind the pushing unit of the brake gear arranged a roller, and the roller is set on the horizontal rail, so when the screw rod drives the brake gear to move axially, the brake gear achieves the effect of smooth displacement.

4. The electronic lock as claimed in claim 1, wherein at the front end of the latch bolt arranged a rolling sleeve for the latch bolt rolling on the bevel edge of the lock slot to enhance the effect of guiding the lock slot aligned to the bolt slot.
